(19) United States
(12) Patent Application Publication
(10) Pub. No.: US 2006/0005010 A1
(43) Pub. Date: Jan. 5, 2006

(54) Identification and authentication system and method for a secure data exchange

(76) Inventors: Henrik Olsen, Nyon (CH); Andre Maisonneuve, Ottawa (CA); Bruce Benn, Ottawa (CA); Thierry Michalowski, Nyon (CH)

Correspondence Address: CHRISTOPHER & WEISBERG, P.A., 200 EAST LAS OLAS BOULEVARD, SUITE 2040, FORT LAUDERDALE, FL, 33301, US

(21) Appl. No.: 10/869,357

(22) Filed: Jun. 16, 2004

(51) Int. Cl. H04L 9/00

(52) U.S. Cl. 713/156

(57) ABSTRACT

An identification and authentication system for secure data exchange over a communications network with a controlled name space, the system having a digital credential generation authority, a credential revocation service, multiple computers, each having: an engine for communicating over the communications network; and at least one application communicating with the engine; at least one domain controller having: an engine for communicating over the communications network; an address resolution service to store network addresses of applications; a key distribution service for distributing keys to engines within the communications network; and a time synchronization module for synchronizing time on engines wherein each of the computers receives a credential for one domain controller authorizing each of the computers to communicate in the system, and each computer further communicates with one domain controller to obtain keys for secure data exchange between applications on the system and the location of applications within the communications network.

### FIELD OF THE INVENTION

The present invention relates to a system and method to facilitate the secure exchange of messages through an electronic communication network and, in particular, to a distributed architecture that allows simple scalability.

### BACKGROUND TO THE INVENTION

Secure communication of messages and data though digital communication networks has increasingly become a requirement for governments, corporations, and individuals. Cyber-terrorism, malicious hacking, and unauthorized access are among many issues relating to secure communications, and these have recently increased the focus on information and data security. The current business environment demands broad and easy access to private and public IP networks like the Internet by remote workers and partners and recognizes that this must be done within a secure environment.

In order to ensure robust security in the exchange of data, including messages, between applications, many aspects of trust and security must be present and operating. These include:
a) the application must ensure that the people accessing it are authorized to do so;
b) the application must trust that other applications sending messages or data are authorized to send these messages or data to the application;
c) the application must trust that the application sending data has not been modified since it has been authorized to send the data;
d) the application must trust that any part of any data transmission, in or out of it, is encrypted at all times and never travels in the clear at any time; and
e) the application must trust that the data it receives has not been modified during the transmit through the digital communication networks.

Various approaches and products have been developed to try to meet these requirements. Common security architectures, approaches, products and standards, such as firewalls, virtual private networks, secure socket layers (SSL), public key infrastructure (PKI), digital credentials and digital signatures generally meet some of the above requirements but still leave corporate data vulnerable to unauthorized access both by external and internal parties.

Further, these security solutions are often complex and costly to implement, costly to manage, costly to maintain, and difficult to scale. Implementations require the use of more than one product, which exacerbates the complexity and costs.

### SUMMARY OF THE INVENTION

The present system and method provides a data security and transport infrastructure for any private and public IP-based communication network, such as the Internet. The system and method ensures the security of messages and documents during transport from one application to another. The present system facilitates the communication between distributed applications.

The present invention therefore provides an identification and authentication system for secure data exchange over a communications network with a controlled name space, said system comprising: a digital credential generation authority for creating and distributing credentials, said credentials having an expiration time; a credential revocation service for distributing a list of revoked credentials; a plurality of computers, each of said plurality of computers having: an engine for communicating over said communications network; at least one application communicating with said engine; and said list received from said credential revocation service; at least one domain controller, each of said at least one domain controller having: an engine for communicating over said communications network; an address resolution service to store a network address of said at least one application; a key distribution service for distributing keys to engines within said communications network; and a time synchronization module for synchronizing time on engines wherein each of said plurality of computers receives a non-revoked credential for one of said at least one domain controller from said digital credential generation authority authorizing each of said plurality of computers to communicate in said system, and each of said computers further communicates with one of said at least one domain controller to obtain keys for secure data exchange between applications on said system and the location of applications within said communications network.

The present invention further provides a method of providing secure data exchange in a communications network comprising the steps of: connecting a computer having an engine and at least one application to a communications network; sending a request from said engine to a digital credential generation authority to obtain a credential for a domain controller; using said credential to communicate between said computer and said domain controller; registering said at least one application with an address resolution service on said domain controller; requesting the address of a second application to which said at least one application wishes to communicate with; obtaining a key from a key distribution service on said domain controller to securely exchange data with said second application; securely exchanging data with said second application using said key.

### BRIEF DESCRIPTION OF THE DRAWINGS

The present system and method is better understood with reference to the drawings in which:

FIG. 1 is a schematic view of the architecture of a preferred embodiment of the present invention;

FIG. 2 is a schematic view of the architecture of the preferred embodiment of the invention showing engines together with a digital credential generation authority and a digital credential generation service;

FIG. 3 is a model showing the OSI model with the method and system of the present invention overlaid on this architecture; and,

FIG. 4 is a schematic showing communication between two applications through the OSI model.

### DETAILED DESCRIPTION OF THE INVENTION

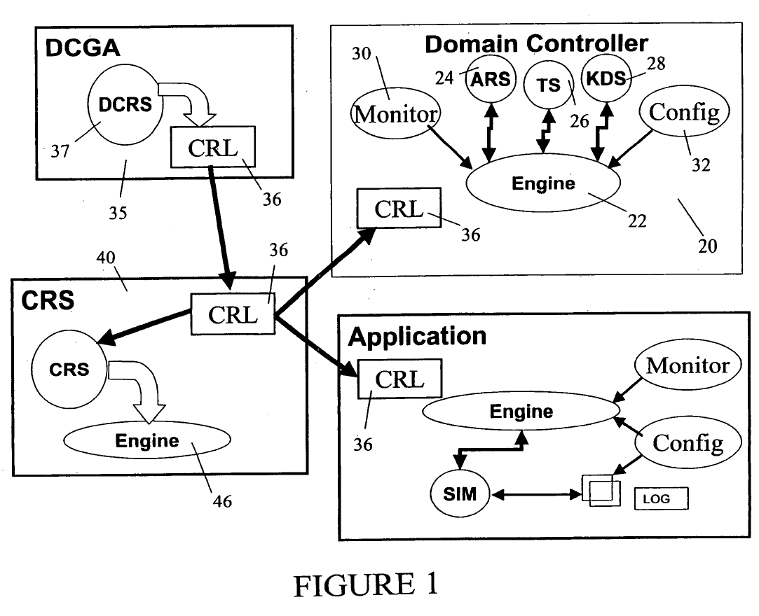

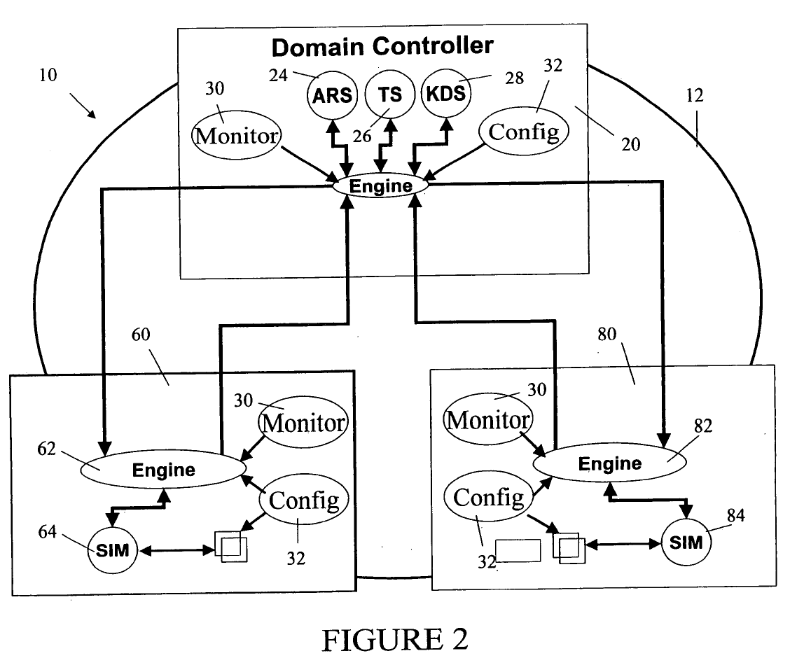

The present system provides an architecture for secure communication between applications over a network, wherein the system is easily scalable and applications can be added without network administrator intervention. Reference is now made to FIGS. 1 and 2.

A system 10 of the present invention comprises one or more domains 12, as seen in FIG. 2 and denoted by the outer circle. A domain is defined as a group of computers linked together through a network and having a domain controller 20. Each domain is managed by one domain controller 20.

In order to establish a domain and authenticate a domain controller, a digital credential generation authority 35 is used. A digital credential generation authority 35 consists of a process 37 for creating digital credentials. Digital credential generation authority 35 further includes a database of revoked digital credentials and prepares a digital credential revocation list 36, which is a list of expired digital credentials. This list is periodically distributed to entities within the system 10, as described below and is used to ensure that domain controllers 20 are authentic.

Digital credential generation authority 35 provides the digital credential revocation list to the digital credential revocation service 40, as seen in FIG. 1. Credential revocation service 40 includes an engine 46 that is used to communicate with entities within system 10 and further stores the credential revocation list 36 as received from the digital credential generation authority 35.

Digital credential generation authority 35, through process 37, creates credentials. Credentials can be certificates, but as one skilled in the art will appreciate, other credentials could be used. These credentials are used to authenticate a domain controller 20 within a domain 12.

A domain controller 20 communicates through its engine 22 with engine 46 to receive the credential revocation list 36 and credentials. The purpose of domain controller 20 is to store a list of applications that are within domain 12 and to further store the location of these applications. Domain controller 20 also has time synchronization module for credential verification and also includes a key distribution service to facilitate communications on a synchronized basis between applications within domain 12, as will be described in more detail below.

The domain controller 20 thus acts as a centralized location to provide keys and address resolution to applications within domain 12. FIG. 1 depicts that domain controller 20 consists of several processes, which may operate on a single computer or be distributed across multiple computers. Domain controller 20 includes an engine 22 for use in communication with other engines on other computers. Communications in the present system and method can only occur between engines and all external communications, therefore, between domain controller 20 and any other computer, go through engine 22. The engine has a unique identifier as will be described below and this identifier, rather than an IP address, is used to communicate with other engines in the computers. In one embodiment of the present invention, all engines are identical and perform the same functions. However, it is contemplated that engines may be distinguished based on the type of computer or the type of applications that they are servicing.

Domain controller 20 further includes an address resolution service 24. Address resolution service 24 contains a list of all engines and all applications operating within a domain 12. When an application connects to the domain 12, it registers its current IP address with the address resolution service 24 and thereafter, the address resolution service 24 knows the IP address of the application. The address resolution service 24 can thereby indicate to one application the IP address of a second application that the first application wants to communicate with.

Domain controller 20 further includes a time synchronization module 26. Time synchronization module 26 provides a logical time between all engines 22 within a domain 12 in order to ensure the logical time within the domains are synchronized. This is required by the fact that encryption keys are time-sensitive and expire at a given time. In order to maintain continuous running and security in the system, the time assigned to the keys must be consistent within the domain 12.

Domain controller 20 further includes a key distribution service 28 which is used to generate, distribute and manage keys that are used within domain 12. All communications between any elements of the domain are encrypted. All keys are generated by the key distribution service 28.

Keys are exchanged between all elements using Kerberos or public/private key methodology. Symmetrical keys generated for sessions between engines use the Kerberos split-ticket technique, as will be known to those skilled in the art. Keys between internal elements and the domain 12 are refreshed at a period specified by a domain administrator.

Domain controller 20 further includes a monitor 30 to report on the operation of the engine 22 and further an engine configurator 32 to set up the operating conditions of engine 22. Configurator can be used to, for example, set up encryption algorithms and key length.

FIG. 1 further illustrates a sample computer 60. Computer 60 includes an engine 62. As indicated above, all communications between computers are done through the engine on the computer and, thus computer 60 will receive and transmit communications through engine 62.

Computer 60 further includes a copy of the credential revocation list 36 as received periodically from the digital credential revocation service 40. This list is used to authenticate that domain controller 20, which is servicing the domain 12 that computer 60 is located in, has a valid digital credential.

Computer 60 further preferably contains one ore more applications 64. An application 64, as shown in FIG. 1, can comprise an instant-messaging service. However, as one skilled in the art will appreciate, other types of applications are envisioned for the present system and method and could include, for example, secure remote file management systems, secure web browsers, secure voice-over IP, secure end-user 2- or 3-factor authentication processes. The present method and system contemplates other applications and contemplates the use of multiple applications on one computer. Each application would connect to engine 62.

Thus, a computer with a running engine 62 and a number of applications linked to that engine is a “node” of domain 12, managed and controlled by domain controller 20. Nodes can exist simultaneously on public and/or on private networks and on different computers. Engine 62 handles all the traffic of the applications that reside on the same computer and engine 62 is enabled to work with the applications to send and receive data.

Engine 62 encrypts and decrypts data from and to the applications using one of multiple encryption algorithms as known to those skilled in the art. All messages destined to, or received from any other uniquely-identified applications are thus encrypted and decrypted.

Reference is now made to FIG. 2. FIG. 2 shows a sample domain 12 which includes two computers 60 and 80 respectively. Domain 12 further includes a domain controller 20. As one skilled in the art will appreciate, the example of FIG. 2 is meant to be illustrative of the present invention and is not meant to limit the scope of the present invention. Specifically, the present invention is not meant to be limited to two computers, nor is it meant to be limited to one application per computer.

Computer 60 includes an engine 62 for communicating with other engines within domain 12. Similarly, computer 80 contains an engine 82 for communicating with other engines within system 10. An application 64 communicates through engine 62 and an application 84 communicates through engine 82. In the present example of FIG. 2, applications 64 and 84 are instant-messaging services.

In operation, computer 60 through engine 62 communicates with credential revocation service 40 which, in turn, communicates with the digital credential generation authority 35 to obtain the credential for the domain controller of the domain 12 that computer 60 is part of. Once it receives this information, computer 60 can communicate with domain controller 20 using public/private key communication. When an application 64 is started, it indicates to engine 62 that it has been added to the system and engine 62 communicates with engine 22 of domain controller 20. Address resolution service 24 receives the address of the application and records that the application exists within the system.

Similarly, computer 80 through engine 82 communicates with credential revocation service 40 which, in turn, communicates with the digital credential generation authority 35 to obtain the credential for the domain controller of the domain 12 that computer 80 is part of. Once it receives this information, computer 80 can communicate with domain controller 20 using public/private key communication. When an application 84 is started, it indicates to engine 82 that it has been added to the system and engine 82 communicates with engine 22 of domain controller 20. Address resolution service 24 receives the address of the application and records that the application exists within the system.

Only one engine need operate on a given machine, with each engine of each machine being uniquely identified. Many applications on a given machine use the same engine to link to other applications within domain 12.

The time from time synchronization module 26 is further propagated to engines 62 and 82. Key distribution service 28 further generates keys that are sent to engines 82 and 84 using a standard split-ticket Kerberos protocol session, as will be known to those skilled in the art. Every time an application wants to exchange data with another application within domain 12, a unique session key is generated by key distribution service 28 in order to encrypt the data of that exchange.

In the present example of FIG. 2, application 64 wishes to communicate with application 84. Key distribution service 28 generates a unique key and, through the private key of computer 1 and computer 2, encrypts this key and passes it to both. Only the two applications exchanging data know this session key since they can decrypt the key. No one anywhere else knows this key, thus providing for secure communication.

In order to communicate, the first application passes data to its engine 62 which then encrypts the data to be sent. Data is carried from engine 62 to engine 82 in a point-to-point manner over a digital communication network such as the Internet. The present invention is not, however, meant to be limited to the Internet, and any other network or means of communicating between computers under the control of a specific name space is contemplated.

Once the data is received at engine 82, it is decrypted and transferred to application 84.

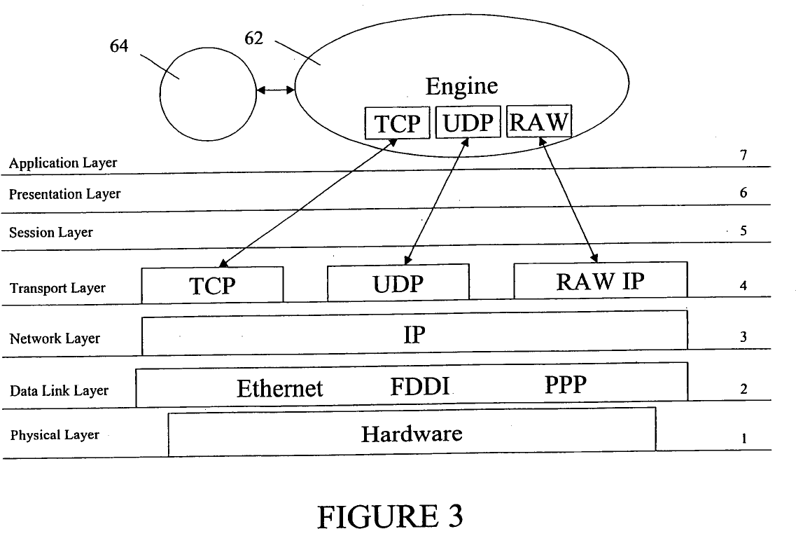

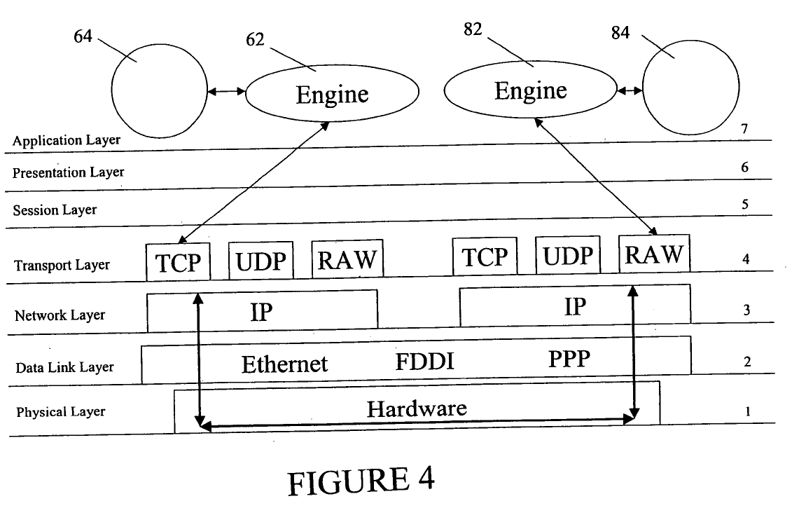

As seen in FIGS. 3 and 4, the present invention controls and ensures data proceeds through the transport layer, the network layer, the data link layer to the physical layer, at which point the data is transferred to the second computer 80 and passed through the data link layer, the network layer and transfer layer to engine 82. The data remains encrypted throughout each of these layers until it reaches the application layer, at which point it is decrypted. Since it is at the application layer that data is decrypted, the method and system herein can operate on any wired or wireless network as messages are encrypted until the application layer and are, therefore, immune to eavesdropping by third parties.

As one skilled in the art will realize, other computers can be added to this system and each will contain an engine and may contain one or more applications communicating with that engine. These computers will similarly register with domain controller 20 through their engines after the engine and domain controller are authenticated using the digital credential generation authority 35.

Thus, domain controller 20 ensures that all entities operating within its domain 12 are properly registered, have authenticated domain controller 20 and have been authenticated by same the domain controller 20. It prevents any unauthorized, unauthenticated or unknown element from carrying any data to any of these entities. Domain controller 20 ensures that applications communicate securely with one another through unique encryption keys known only to the communicating applications.

One embodiment of the present invention, a proprietary addressing scheme, is used to regulate communications within system 10. Exchanges can only take place between engines authorized to operate within system 10 and this is regulated through this proprietary addressing scheme. Messages that do not use the proprietary addressing scheme are ignored, thereby reducing the chances of a successful attack on system 10 from outside sources.

A proprietary addressing scheme assigns a “Receiver” within engine 22 an address in order to receive messages from “Transmitters”. Transmitters have no addresses, as they are used for sending messages only. Addresses do not identify the processes that exchange data as processes are identified at the application level.

In one embodiment of the invention, all receivers on one computer have unique identifiers within this computer, referred to herein as Receiver_ID. All computers in a domain 12 have unique identifiers within this domain and are assigned a Computer_ID. Further, all domains 12 within a given digital credential revocation service 40 environment have unique identifiers referred to as Domain_ID.

Based on the above, a receivers address will look like Domain_ID/Computer_ID/Receiver_ID. Alternatively, applications can create identification for receivers using aliases. The name of the receiver is the alias name for some part of the address, for example, Domain_ID/Alias_Name

For the effective operation of system 10, the address of a receiver consists of various elements to ensure the correct delivery of messages transported through system 10 and to exclude double-address resolution.

In a preferred embodiment, Domain_ID identifier of a domain uses either text line in DNS format or by a 32-bit IP address in dword format. The Computer_ID is the computer identifier and is preferably a 32-bit number in dword format. The Receiver_ID is a unique number used by the local component of system 10 to control the incoming local message flows and is preferably a 32-bit number in dword format. The Alias name is a receiver Alias name or service name or unique name within the system 10. It is introduced in the text line format and contains either a unique name or a text representation of 128-bit number in hex-decimal notation.

In the preferred system, services can create receivers with different degrees of name uniqueness in order to control the quantity and configuration of these services within the domain and computer.

As described above, in order for an application to interact on domain 12, it must first register with domain controller 20. This is accomplished by registering the application with address resolution service 24. Address resolution service 24 assigns the application a unique address according to the proprietary addressing scheme described above.

To enable domain controller 20 to route and deliver messages correctly, system 10 contains a receiver's address. The address space of the engine 62 is mapped to the address space of the network upon which system 10 is implemented, for example to the IP network address space of the Internet

The infrastructure of the present system provides for symmetrical encryption of the data and is, thus, faster than systems which use asymmetrical encryption that are common within the digital credential-based authentication mechanisms used currently, such as public key infrastructures. These keys are securely passed to both applications on a standard split-ticket Kerberos protocol session as described above.

System 10 is largely self-managed, as all mutual authentication and key exchanges are performed internally and automatically, without requiring outside intervention. A new engine coming into a domain 12 will find, through the digital credential revocation service 40, the location and public key of its domain controller 20. It can then communicate with domain controller 20 to establish communications with other engines within domain 12.

The combination of these processes is a novel way to greatly facilitate exchange data between applications and can be performed through any IP-based networks or through any communications network under the control of a specific name space. Further, no external certification authority is required as all parties to a communication are authenticated within system 10.

Network management in the present method and system is simplified over the prior art by making applications independent of their physical location on the network and thus eliminating the requirement of changing this physical location in the case of a change in the application location or of the network topology. Specifically, an application, when brought on-line, registers with the address resolution service 22 and, thereafter, system 10 knows the location of that application under the control of the specific name space of the specific network.

The present system further facilitates presence management since an engine registers the IP address of any application present on the system with the address resolution service 24. This information can be passed to other applications present in the same domain 12 at the same time.

IP address independence is further achieved through the use of an addressing scheme assigning unique logical addresses instead of specific addresses in the name space of the supporting network.

The above is meant to be illustrative of the present system and method, and is not meant to limit the present system and method. This system and method are only meant to be limited by the claims below.

We claim:

1. An identification and authentication system for secure data exchange over a communications network with a controlled name space, said system comprising:
a) a digital credential generation authority for creating and distributing credentials, said credentials having an expiration time;
b) a credential revocation service for distributing a list of revoked credentials;
c) a plurality of computers, each of said plurality of computers having:
i. an engine for communicating over said communications network;
ii. at least one application communicating with said engine; and
iii. said list received from said credential revocation service;
d) at least one domain controller, each of said at least one domain controller having:
i. an engine for communicating over said communications network;
ii. an address resolution service to store a network address of said at least one application;
iii. a key distribution service for distributing keys to engines within said communications network; and
iv. a time synchronization module for synchronizing time on engines,
wherein each of said plurality of computers receives a non-revoked credential for one of said at least one domain controller from said digital credential generation authority authorizing each of said plurality of computers to communicate in said system, and each of said computers further communicates with one of said at least one domain controller to obtain keys for secure data exchange between applications on said system and the location of applications within said communications network.

2. The system of claim 1, wherein said at least one application communicates with said engine through an application layer on said plurality of computers.

3. The system of claim 1, wherein said credential is a digital credential issued internally.

4. The system of claim 1, wherein said credential is only valid if it is not within the list of revoked credentials.

5. The system of claim 1, wherein said keys for secure data exchange between applications are symmetric keys.

6. The system of claim 1, wherein said key distributed by said key distribution service is distributed to said engines using a split-ticket Kerberos session.

7. The system of claim 1, wherein communications between applications uses an addressing scheme distinguishable from an Internet Protocol address.

8. The system of claim 7, wherein the addressing scheme includes a unique identifier to identify a receiver on an engine within said plurality of computers.

9. The system of claim 8, wherein the unique identifier includes a domain identifier for the domain of the receiver.

10. The system of claim 9, wherein the unique identifier includes a computer identifier.

11. The system of claim 8, wherein the unique identifier includes a receiver identifier.

12. The system of claim 9, wherein the unique identifier further includes an alias name for the receiver.

13. The system of claim 1, wherein said system allows all mutual authentication and key exchanges to be performed internally.

14. The system of claim 1, wherein movement of an application to a new network address is recorded in the address resolution service, thereby simplifying dynamic network management.

15. A method of providing secure data exchange in a communications network comprising the steps of:
a. connecting a computer having an engine and at least one application to a communications network with a controlled name space;
b. sending a request from said engine to a digital credential generation authority to obtain a credential for a domain controller;
c. receiving a non-revoked credential at said computer.
d. using said credential to perform authentication by said computer of said domain controller;
e. registering said at least one application with an address resolution service on said domain controller;
f. requesting the address of a second application to which said at least one application wishes to communicate with;
g. obtaining a key from a key distribution service on said domain controller to encrypt and thus securely exchange data with said second application;
h. securely exchanging data with said second application using said key.

16. The method of claim 15 wherein the step of securely exchanging data uses a symmetrical encryption key.

17. The method of claim 15, wherein the obtaining step uses a split-ticket Kerberos session to distribute said key.
